(19) United States
(12) Patent Application Publication
(10) Pub. No.: US 2004/0213411 A1
(43) Pub. Date: Oct. 28, 2004

(54) Audio data processing device, audio data processing method, its program and recording medium storing the program

(75) Inventor: Kei Sakagami, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/828,260

(22) Filed: Apr. 21, 2004

(30) Foreign Application Priority Data
Apr. 25, 2003 (JP) 2003-122508

(51) Int. Cl. H04R 5/00

(52) U.S. Cl. 381/1

(57) ABSTRACT

A reproducing time until audio data is transmitted to a speaker (300) connected in a wireless transmission system is converted into a sound travel distance. A computing section (213F) performs delay processing so that the audio data transmitted for a shorter distance becomes equal to the one for a longer distance based on a parameter information on a delay time of a data area stored in a memory (213E) when comparing the sum of the sound travel distance and another locating distance to the speaker (300) from a reference point and a locating distance of the speaker in a wired transmission system. Image data is also delayed corresponding to a maximum delay time of the audio data so as to reproduce the image data on a display (400).

### BACKGROUND OF THE INVENTION

1. Field of the Invention

The present invention is related to an audio data processing device, an audio data processing method, its program and a recording medium storing the program for processing audio data to be output from a plurality of speakers.

2. Description of Related Art

A known reproducing system reproduces multichannel audio data with use of a plurality of speakers. For instance, the reproducing system displays image data on a monitor and reproduces audio data the plurality of speakers located around the audience. According to such reproducing system, it is difficult to locate the respective speakers to be equidistant from the audience since the speakers must be arranged within a limited living space. In order to avoid that the sound respectively reproduced from the speakers reach the audience at unsynchronized timings on account of the distance difference of the speakers from the audience, there is another known art that delays audio data when processing the audio data so that sound reach an audience at a synchronized timing. For example, refer to prior art 1 (Japanese Patent Publication S56-45360, right column on page 1 to right column on page 2) and prior art 2 (Japanese Patent Publication H2-1440, right column on page 2 to right column on page 4).

An arrangement disclosed in prior art 1 relatively adjusts the level of two-channels signals with respect to the time difference of acoustic waves that travel distances between respective speakers and an audience, i.e., controls travel times of multichannel signals by relatively delaying output signal waves. An arrangement disclosed in prior art 2 processes amplified gains of audio data according to a relative delay time in proportional to the difference of distances between respective speakers and an audience.

Speakers located at the backside of the audience, i.e., those arranged away from an audio data processing device such as an amplifier preferably employs a wireless system for reproducing and outputting audio data by and from the amplifier to the speakers via a radio medium. The wireless system modulates and demodulates the audio data for reproducing and outputting the audio data by and from the speakers. Therefore, as described in prior arts 1 and 2, the system that delays the audio data simply according to the relation of locating distances is inadequate since the audio data to be output from the respective speakers reach the audience at unsynchronized timings, thereby providing undesirable sound.

### SUMMARY OF THE INVENTION

An object of the present invention is to provide an audio data processing device, an audio data processing method, its program and a recording medium storing the program for synchronizing a timing of sound to be reproduced by different transmission systems.

An audio data processing device according to an aspect of the present invention for reproducing audio data from a plurality of speakers located around a reference point, the device includes: an audio data acquiring section for acquiring the audio data; and a delay processor for selectively delaying audio data transmitted to a first speaker connected by way of wiring in a wired transmission system out of the audio data of channels respectively corresponding to the speakers on the basis of a time until the audio data transmitted to a second speaker connected by way of a radio medium in a wireless transmission system is reproduced from the second speaker.

An audio data processing method according to another aspect of the present invention for reproducing audio data from a plurality of speakers located around a reference point, the system includes the step of selectively delaying audio data transmitted to a first speaker connected by way of wiring in a wired transmission system out of the audio data of channels respectively corresponding to the speakers on the basis of a time until the audio data transmitted to a second speaker connected by way of a radio medium in a wireless transmission system is reproduced from the second speaker.

An audio data processing program according to a still another aspect of the present invention executes the above-described audio data processing method by the computing section.

A recording medium according to a further aspect of the present invention stores the above-described audio data processing program in a manner readable by the computing section.

### BRIEF DESCRIPTION OF THE DRAWINGS

FIG. 1 is a block diagram schematically showing structure of a player according to an embodiment of the present invention;

FIG. 2 is a conceptual diagram showing arrangement of speakers respectively located at relative distances being delayed in a same transmission system according to the embodiment;

FIG. 3 is a conceptual diagram showing arrangement of speakers respectively located at relative distances being delayed in different transmission systems are applied according to the embodiment;

FIGS. 4A and 4B are conceptual diagrams each showing data structure of a memory according to the embodiment, in which FIG. 4A represents a standard data area and FIG. 4B represents a data area;

FIG. 5 is a block diagram schematically showing status of delay processing in the same transmission system according to the embodiment;

FIG. 6 is a block diagram schematically showing status of delay processing in the different transmission systems according to the embodiment;

FIG. 7 is a conceptual diagram showing a result of delay processing when all speakers are connected in a wired transmission system as well as a display according to the embodiment;

FIG. 8 is a conceptual diagram showing a result of delay processing when certain speakers are connected in a wireless transmission system with a delay time of 12 msec according to the embodiment;

FIG. 9 is a conceptual diagram showing a result of delay processing when certain speakers are connected in the wireless transmission system with a delay time of 11 msec according to the embodiment;

FIG. 10 is a conceptual diagram showing a result of delay processing when certain speakers are connected in the wireless transmission system with a delay time of 10 msec according to the embodiment.

### DETAILED DESCRIPTION OF PREFERRED EMBODIMENT(S)

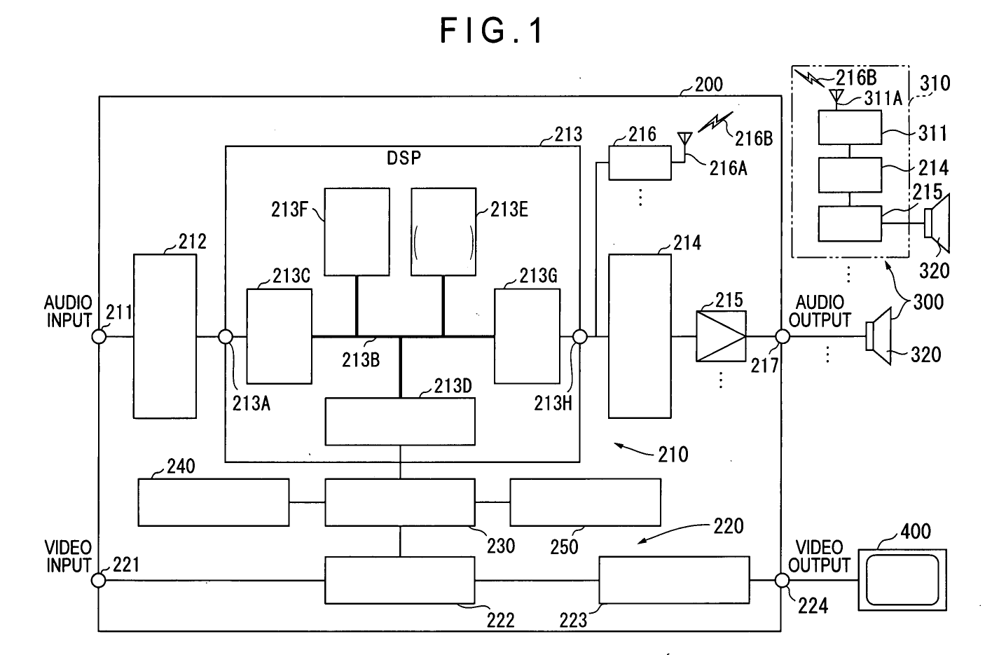

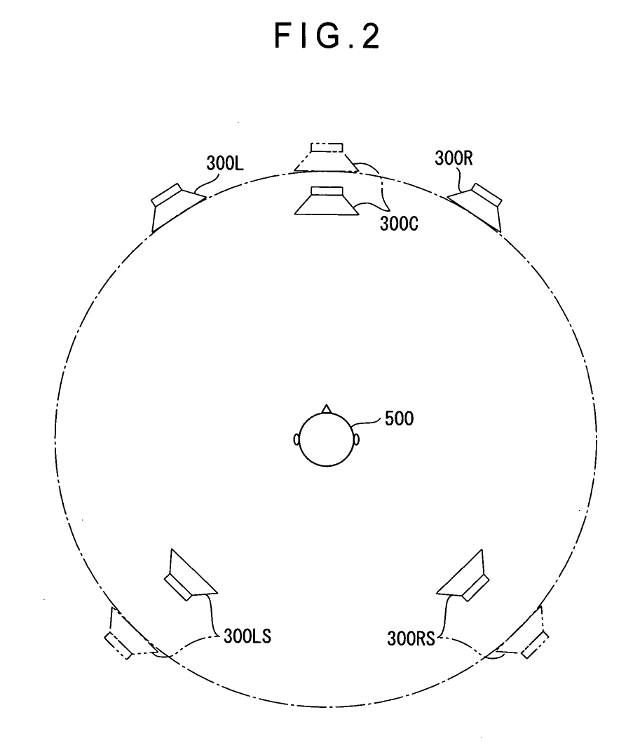

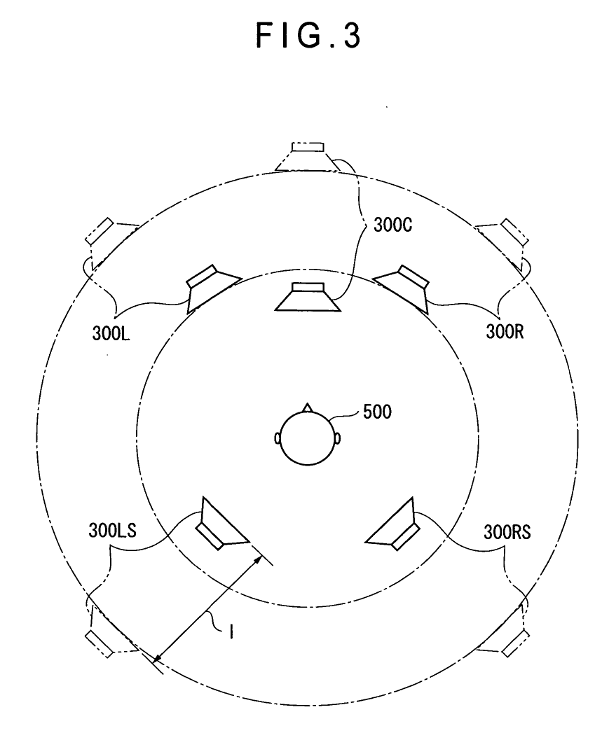

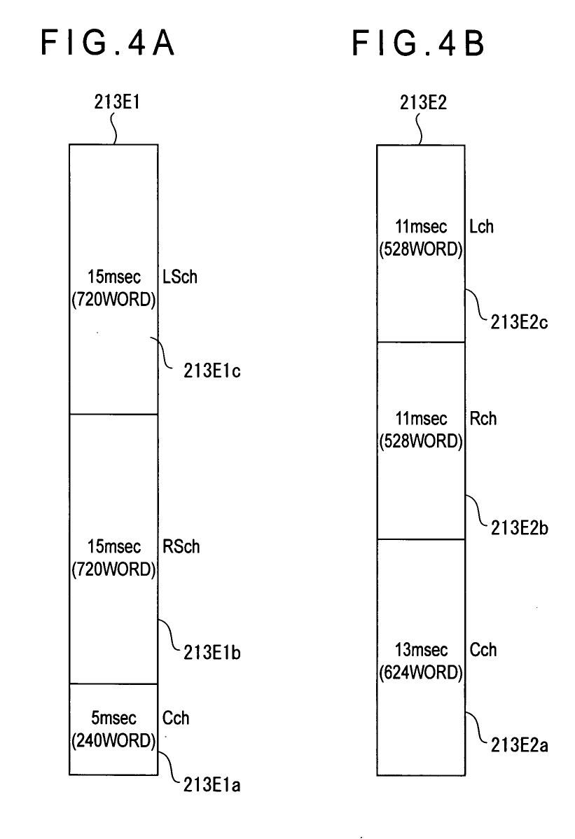

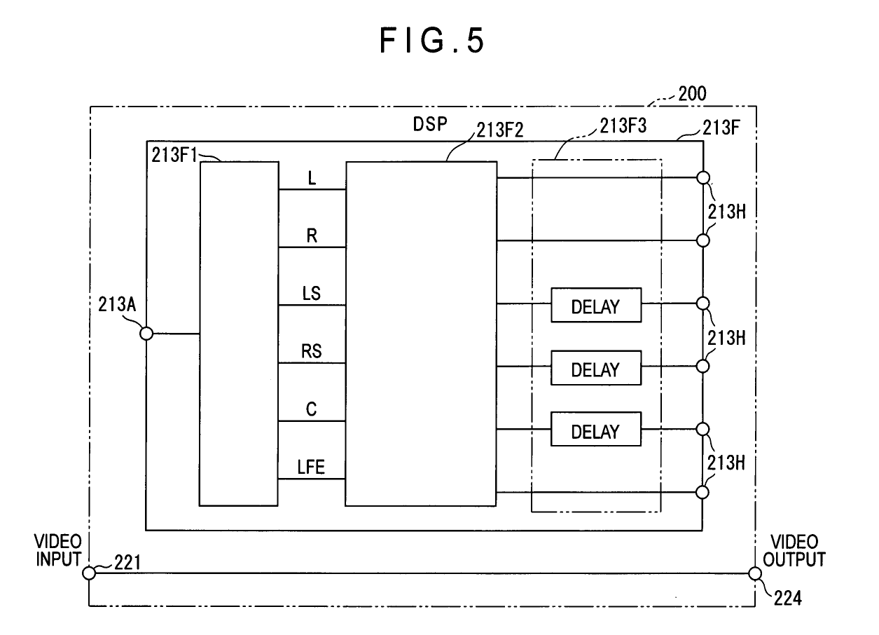

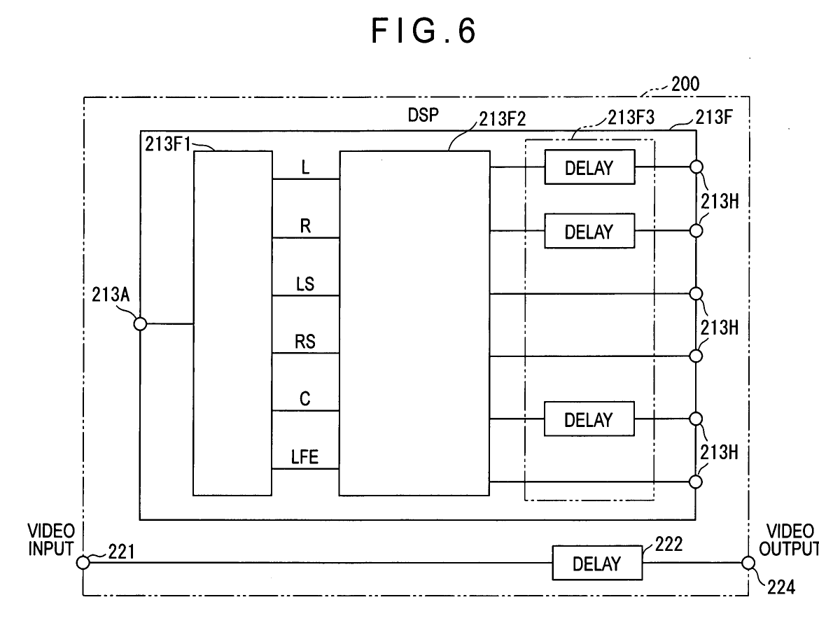

A player according to an embodiment of the present invention will be described below with reference to attached drawings. Though audio data and image data are reproduced and output according to this embodiment, only audio data may be reproduced and output. FIG. 1 is a block diagram that schematically shows structure of the player. FIG. 2 is a conceptual diagram showing arrangement of speakers respectively located at relative distances being delayed in a same transmission system. FIG. 3 is a conceptual diagram showing arrangement of speakers respectively located at relative distances being delayed in different transmission systems. FIGS. 4A and 4B are conceptual diagrams each showing data structure of a memory, in which FIG. 4A represents a standard data area and FIG. 4B represents a data area. FIG. 5 is a block diagram schematically showing status of delay processing in the same transmission system. FIG. 6 is a block diagram schematically showing status of delay processing in the different transmission systems.

[Structure of Player]

(Structure)

In FIG. 1, a reference numeral 100 denotes a player. The player 100 reproduces and outputs audio data and image data in an audible and viewable manner. The player 100 includes a data reading section (not shown), a signal processor 200 (an audio data processor), a plurality of speakers 300 and a display 400. As indicated by the solid lines in FIGS. 2 and 3 for instance according to this embodiment, the plurality of speakers 300 includes: a center speaker 300C (a first speaker) located at the position adjacent to the display 400 in the front of an auditory position (a referential point), i.e., an audience 500; a right front speaker 300R (a first speaker) located at the front right side of the audience; a left front speaker 300L (a first speaker) located at the front left side of the audience; a right rear speaker 300RS (a second speaker) located at the rear right side of the audience; and a left rear speaker 300LS (a second speaker) located at the rear left side of the audience. Though this embodiment has the above five speaker channels, two or more speaker channels may be applied to structure with use of two or more speakers for reproducing and outputting multichannel audio data. For example, a speaker for reproducing low frequency effect corresponding to 0.1 channel (ch) of so called 5.1 ch system is applicable. Further, a player dedicated to listening audio data without the display 400 is also applicable.

The data reading section includes a drive or a driver for reading various data stored in a recording medium. The recording medium may be applied to a CD-DA (Compact Disk), a DVD (Digital Versatile Disc), a recording disk such as a hard disk, or a certain recording media such as a memory card. The data reading section respectively outputs the read audio data and image data from output terminals (not shown).

The signal processor 200 is, for instance, an AV (Audio-Visual) receiver. As shown in FIG. 1, the signal processor 200 has an audio processor 210, an image processor 220, a microcomputer 230, an input operating section 240 and a monitor 250. The microcomputer 230 is connected to the audio processor 210 and the image processor 220 and controls operations of the audio processor 210 and the image processor 220.

The input operating section 240 is connected to the microcomputer 230 and provided with a plurality of switches such as operation buttons and knobs (not shown) that enable input operation. The input operating section 240 outputs a predefined signal to the microcomputer 230 in response to the input operation of the switches so that the microcomputer 230 set various parameters. Note that the configuration of the input operating section 240 is not limited to the switches, and any configurations may be used such as voice. The input operation may be performed with a remote controller so that a signal corresponding to the input operation is transmitted to the microcomputer 230 via a radio medium for setting.

The monitor 250 is connected to the microcomputer 230 and provided with a display device such as a liquid crystal panel or an EL (Electro Luminescence) panel. As the microcomputer 230 controls, the monitor 250 displays status of processing and reproducing/outputting the audio data, or contents of the input operation based on the signal output from the microcomputer 230.

The audio processor 210 is controlled by the microcomputer 230 to reproduce and output the audio data from the respective speakers 300 as sound. The audio processor 210 has an audio input terminal 211, a digital interface receiver (DIR) 212 as an audio data acquiring section, a digital signal processor (DSP) 213 as an audio data processing device, a digital to analog converter (DAC) 214, a plurality of amplifiers 215, a plurality of transmitters 216 as transmitting sections and a plurality of output terminals 217 for audio data. According to this embodiment, for instance, there are provided the three amplifiers 215 and the three output terminals 217 for audio data corresponding to the center speaker 300C, the right front speaker 300R and the left front speaker 300L.

The input terminals 211 for audio data is, for example, a connector releasably connected to an end of a lead wire (not shown). The audio input terminal 211 is connected to the data reading section, which is connected to a terminal (not shown) arranged at another end of the lead wire via the lead wire so that the audio data output from the data reading section is input.

The DIR 212 is connected to the audio input terminal 211. The DIR 212 acquires and converts the audio data input to the audio input terminal 211 to output the converted data as a stream audio data.

The DAC 214 is connected to the DSP 213 and converts a digital audio data output from the DSP 213 into an analog audio data. Then, the DAC 214 outputs the audio data converted into analog to the respective amplifiers 215.

Each amplifier 215 is connected to DAC 214 and the audio output terminal 217. For instance, there are provided the five amplifiers 215 corresponding to the number of the speakers 300. The amplifier 215 processes the analog audio data so that the speaker 300 can output the processed data, and outputs the data to the audio output terminal 217.

The audio output terminal 217 is a connector releasably connected to a terminal (not shown) arranged at an end of a lead wire. The audio output terminal 217 is connected to each of the respective speakers 300, which is connected to a terminal disposed at another end of the lead wire via the lead wire so that the audio data output from each amplifier 215 is output to each speaker 300. Specifically, there are provided the five output terminals 217 for audio data to be connected to the respective speakers 300.

The transmitter 216 has a transmitting antenna 216A, and is connected to the DSP 213. The transmitter 216 modulates the processed digital audio data output from the DSP 213, and transmits the modulated data to the predefined speaker(s) 300 from the transmitting antenna 216A, the modulated data being carried by a radio medium 216B. The radio medium 216B may be applied to any of light beams such as infrared rays, sound waves, electric waves and electromagnetic waves.

The DSP 213 is connected to the DIR 212, the DAC 214 and the transmitter 216. The DSP 213 acquires the stream audio data output from the DIR 212, delays and outputs the acquired data to the DAC 214 or the transmitter 216. The DSP 213 has an input terminal 213A, a data bus 213B, an stream data input section 213C, a host interface 213D, a memory 213E as a storage, a computing section 213F as a delay processor, an audio output section 213G and an output terminal 213H.

The input terminal 213A is connected to the DIR 212. The stream audio data output from the DIR 212 is input to the input terminal 213A. The stream data input section 213C is connected to the input terminal 213A and the data bus 213B. The input section 213C acquires the stream audio data input from the DIR 212 to the input terminal 213A and outputs the acquired data to the data bus 213B. The host interface 213D is connected to the microcomputer 230 and the data bus 213B. The host interface 213D outputs a command signal to the computing section 213F from the microcomputer 230 via the data bus 213B to operate the computing section 213F. The audio output section 213G is connected to the data bus 213B and the output terminal 213H. The output section 213G acquires the audio data previously processed by the computing section 213F (the specific process is described below) from the data bus 213B to output the acquired data to the output terminal 213H.

The memory 213E stores a program for processing the stream audio data, a processing parameter for delaying the predefined stream audio data and the like. The memory 213E has, for instance as shown in FIGS. 4A and 4B, a standard data area 213E1 (FIG. 4A) where delay times corresponding to a same transmission system are assigned, and a data area 213E2 (FIG. 4B) where delay times corresponding to different transmission systems are assigned. The delay times are so defined by applying the positional relationship of the respective speakers 300 as shown in FIGS. 2 and 3. To be more specific, the right front speaker 300R and the left front speaker 300L each is located at the farthermost position relative to the audience 500, the center speaker 300C is located at the position slightly closer than the speakers 300R and 300L, and the right rear speaker 300RS and the left rear speaker 300LS each is located at the nearest position. For instance, a wired transmission system that connects the speakers 300 via a lead wire (not shown) and a wireless transmission system that connects the speakers 300 via the radio medium 216B are employed for a transmission system. In this embodiment, the right rear speaker 300RS and left rear speaker 300LS employ the different transmission systems from other speakers.

As shown in FIG. 2, delay times, each one of which becomes longer as the distance between each speaker 300 and the auditory position (the referential point) becomes shorter is assigned to the standard data area 213E1. In other words, the standard data area 213E1 represents a delay time that the audience 500 can listen to sound reproduced by and output from the speakers 300 with a synchronized timing by delaying audio data C, RS and LS, just like the case that the speakers 300 are equidistant from the auditory position as indicated by the double-dashed chained lines in FIG. 2. More specifically, as shown in FIG. 4A, the standard data area 213E1 has: an area 213E1a that can store the audio data C reproduced by and output from the center speaker 300C with 240 words, the delay time thereof for delay-processing being 5 msec at a maximum; an area 213E1b that can store the audio data RS reproduced by and output from the right rear speaker 300RS with 720 words, the delay time thereof for delay-processing being 15 msec at a maximum; and an area 213E1c that can store the audio data LS reproduced by and output from the left rear speaker 300LS with 720 words, the delay time thereof for delay-processing being 15 msec at a maximum.

As shown in FIG. 3, delay times, each one of which becomes longer as a distance 1 and another distance become shorter are assigned to the data area 213E2. The distance 1 from the referential point to the speaker 300RS or 300LS is defined by converting the time necessary for acquiring and demodulating the modulated audio data RS, LS transmitted from the transmitter 216 by the speakers 300RS, 300LS. Another distance is from the referential point to the speaker 300C, 300R or 300L. In other words, the data area 213E2 represents delay times that enable the audience 500 to listen to the sound reproduced by and output from the speakers 300 with a synchronized timing by delay-processing audio data C, R and L as the case that the speakers 300 are equidistant from the auditory position as indicated by the double-dashed chained lines in FIG. 3. More specifically, as shown in FIG. 4B, the standard data area 213E2 has: an area 213E2a that can store the audio data C reproduced by and output from the center speaker 300C with 624 words, the delay time thereof for delay-processing being 13 msec at a maximum; an area 213E2b that can store the audio data R reproduced by and output from the right front speaker 300R with 528 words, the delay time thereof for delay-processing being 11 msec at a maximum; and an area 213E2c that can store the audio data L reproduced by and output from the left front speaker 300L with 528 words, the delay time thereof for delay-processing being 11 msec at a maximum. The standard data area 213E1 and the data area 213E2 both are available for 1680 words in total.

The computing section 213F is connected to the data bus 213B. In response to the command signal from the microcomputer 230, the computing section 213F processes the stream audio data output from the stream data input section 213C to the data bus 213B in accordance with the program and the processing parameter stored in the memory 213E. As shown in FIGS. 5 and 6, the computing section 213F includes a decoder 213F1 as a program, an audio processor 213F2, a delay processor 213F3 and the like. FIG. 5 is a block diagram showing structure for delay processing when the same transmission system is applied. FIG. 6 is a block diagram showing structure for delay processing in the different transmission systems is applied. As described above, referring to FIG. 6, the right rear speaker 300RS and the left rear speaker 300LS employ the wireless transmission system, and other speakers employ the wired transmission system.

The decoder 213F1 decodes the stream audio data and splits the data into audio data L, R, LS, RS, C and LFE (Low Frequency Effect), i.e., the channels respectively corresponding to the speakers 300. The LFE is corresponding to 0.1 channel (ch) of so called 5.1 ch system, i.e., a channel containing only the low frequency effect. The audio processor 213F2 applies audio signal processing to the audio data L, R, LS, RS, C and LFE output from the decoder, and adjusts, for instance, the volume set by the input operation with the input operating section 240 and the balance of reproducing/outputting the data. The delay processor 213F3 delays the audio data, to which the audio signal processing is applied by the audio processor 213F2, based on the processing parameter previously set to define the speakers 300 employing the wireless transmission system as a wireless speaker. The computing section 213F, therefore, outputs the delayed audio data to the audio output section 213G via the data bus 213B.

As mentioned above, in response to the input operation with the input operating section 240, the delay processing may select either an arrangement that all speakers 300 acquire the audio data with the same transmission system as shown in FIG. 5, or an arrangement that certain speakers 300 acquire the audio data with the different transmission system as shown in FIG. 6. As mentioned above, the wired transmission system that connects the speakers 300 via the lead wire (not shown) and the wireless transmission system are employed for the transmission system in this embodiment.

As shown in FIG. 5, when all of the speakers 300 employs either the wired transmission system or the wireless transmission system, the delay processor 213F3 delays the audio data C, RS, LS, the speakers 300 of which are arranged closer to the audience, based on the delay times assigned to the standard data area 213E1 of the memory 213E. Other audio data R, L are output to the output terminal 213H via the audio output section 213G without delay processing. As shown in FIG. 6, when certain speakers 300 employs the wireless transmission system, the delay processor 213F3 delays the audio data C, R, L, the speakers 300 of which are arranged relatively farther from the audience with respect to the time for modulating and demodulating, based on the parameter of the data area 213E2 of the memory 213E. Other audio data RS, LS are output to the output terminal 213H via the audio output section 213G without delay processing.

The image processor 220 is controlled by the microcomputer 230 to reproduce and output the image data as video picture on the display. As shown in FIG. 1, the image processor 220 includes an image input terminal 221 as an image data acquiring section, a delay circuit 222 as an image data delay processor, a video output circuit 223 and an image output terminal 224.

The image input terminal 221 is, for example, a connector releasably connected to an end of a lead wire (not shown). The image input terminal 221 is connected to the data reading section, which is connected to a terminal (not shown) arranged at another end of the lead wire via the lead wire so that the image data output from the data reading section is input.

The delay circuit 222 is connected to the image input terminal 221 and the microcomputer 230. The delay circuit 222 is controlled by the microcomputer 230 to delay and output the image data by the maximum delay time according to the parameter for delaying the audio data by the audio processor 210. In other words, as shown in FIG. 5, when all of the speakers 300 are connected in the wired transmission system that takes a shorter time to reproduce and output the audio data, the delay circuit 222 does not delay the image data. As shown in FIG. 6, when certain speakers 300 are connected according to the wireless transmission system that takes a longer time until the completion of reproducing/outputting the audio data because of modulating and demodulating, the delay circuit 222 delays the image data. The delay processing is conducted by the maximum delay time according to the parameter for delaying the audio data by the audio processor 210. When all of the speakers 300 employ the wireless transmission system and the display 400 employs the wired transmission system, the image data is delayed. Alternatively, when the display 400 employs the wireless transmission system as well as all of the speakers 300, the image data is not delayed.

The video output circuit 223 is connected to the delay circuit 222 and the image output terminal 224. The video output circuit 223 processes the delayed image data output from the delay circuit 222 so that the image data can be displayed on the display 400. The video output circuit 223 outputs the processed image data to the image output terminal 224.

The image output terminal 224 is a connector releasably connected to a terminal (not shown) arranged at an end of a lead wire. The image output terminal 224 is connected to the display 400, which is connected to a terminal arranged at another end of the lead wire via the lead wire so that the image data output from the video output circuit 223 is output to the display 400.

As shown in FIG. 1, each speaker 300 has a reception processor 310 and a speaker body 320. The reception processor 310 includes a receiver 311, a DAC 214 and an amplifier 215 just like the above-described audio processor 210.

The receiver 311 is provided with a reception antenna 311A. The receiver 311 receives the modulated audio data transmitted from the transmitter 216 of the audio processor 210, the modulated audio data being carried by the radio medium 216B, and modulates the received data to output to the connected DAC 214. The reception processor 310, just like the audio processor 210, converts the demodulated audio data into analog audio data, processes the converted data so that the audio data can be reproduced by and output from the speaker body 320 connected to the reception processor 310 via the amplifier 215, and outputs the audio data to the speaker body 320 to reproduce. As shown in FIG. 1, when the speaker 300 is connected to the audio output terminal 217, the audio output terminal 217 is connected to the speaker body 320 via other terminals (not shown).

The display 400 may use a display device such as a liquid crystal panel, an EL (Electro Luminescence) panel, a PDP (Plasma Display Panel) or a cathode-ray tube. The display 400 acquires the image data output from the output terminal for image data to reproduce and output the data as video picture.

(Delay Processing in Digital Signal Processor)

Next, the delay processing in the DSP 213, i.e., the setting of delay times assigned to the memory 213E for delay processing will be described below.

The delay processor 213F3 of the DSP 213 delays the audio data based on the parameter stored in the memory 213E as described above. There are provided two parameters for delay processing that the first one is stored in the standard data area 213E1 utilized when all of the speakers 300 are connected in the wired transmission system. The second one is stored in the data area 213E2 utilized when certain speakers 300 are connected in the wireless transmission system. For instance, the data area 213E2 is utilized when the right rear speaker 300RS and the left rear speaker 300LS employ the wireless transmission system, and other speakers and the display employ the wired transmission system, as described above.

When all of the above components employ the wired transmission system, the delay time of each component is calculated according to equations 1 and 2. Specifically, the delay time of 5 msec at a maximum for delaying the audio data C reproduced by and output from the center speaker 300C is assigned to the area 213E1a of the standard data area 213E1, the delay time of 15 msec at a maximum for delaying the audio data RS or LS reproduced by and output from the right rear speaker 300RS or the left rear speaker 300LS is assigned to the area 213E1b or 213E1c of the data area 213E1. In the ordinary condition, a delay time S of the audio data RS or LS is calculated as indicated by equation 1, a delay time C of the audio data C is calculated as indicated by equation 2. Note that alphabetic characters in equations 1 and 2 represent the following.

S: delay time [msec] for audio data RS or LS

C: delay time [msec] for audio data C

f: distance [m] from reference point to right front speaker 300R or left front speaker 300L

c: distance [m] from reference point to center speaker 300C

s: distance [m] from reference point to right rear speaker 300RS or left rear speaker 300LS

v: acoustic velocity [m/s]

S=1000*(f−s)/v Equation 1

if S>15, then S=15

if S<0, then S=0

C=1000*(f−c)/v Equation 2

if C>5, then C=5

if C<0, then C=0

On the other hand, when the right rear speaker 300RS and the left rear speaker 300LS employ the wireless transmission system, the delay time is calculated based on equations 3 and 4. Specifically, the delay time of 13 msec at a maximum for delaying the audio data C reproduced by and output from the center speaker 300C is assigned to the area 213E2a of the data area 213E2, the delay time of 11 msec at a maximum for delaying the audio data R or L reproduced by and output from the right front speaker 300R or the left front speaker 300L is assigned to the area 213E2b or 213E2c of the data area 213E2. When certain speakers employ the wireless transmission system, a delay time F of the audio data R or L is calculated as indicated by equation 3, and a delay time C of the audio data C is calculated as indicated by equation 4. Note that alphabetic characters in equations 3 and 4 represent the following though the previously mentioned characters are abbreviated.

F: delay time [msec] for audio data R or L

1: sound travel distance (1=t*V/1000) [m] relevant to delay time at wireless transmission

t: delay time at wireless transmission

Fmax: maximum delay time [msec] for audio data R or L

Cmax: maximum delay time [msec] for audio data C

F=1000*((s+1)−f)/v Equation 3

if F>Fmax, then F=Fmax

if F<0, then F=0

C=1000*(f−c)/v+F Equation 4

if C>Cmax, then C=Cmax

if C<0, then C=0

Accordingly, since the delay times calculated by equations 1 through 4 are applied to delay processing on the basis of reproducing time until the completion of reproducing the audio data as the sound in the wireless transmission system, the sound respectively reproduced by and output by the speakers reach the reference point at a synchronized timing.

[Reproducing Processing of Player]

Now, reproducing processing of the player will be described below with reference to attached drawings.

(Reproducing Operation)

The speakers 300 and the display 400 are arranged according to the certain positional relationship within a predefined location range. The speakers 300 and the display 400 are connected to the signal processor 200 together with the data reading section (not shown), and then the player 100 is arranged. As the arrangement is fixed, the data reading section and the signal processor 200 are powered, thereby supplying electric power. According to the input operation with the input operating section 240, the speakers 300 are set in either the wired transmission system or the wireless transmission system, and also set so that the audio data respectively reproduced by and output from the speakers 300 reach the auditory point (the reference point) at a synchronized timing. The set parameter is stored in the memory 213E. Then, the data reading section is driven to read audio data and image data stored in a recording medium and output the read data to the signal processor 200.

The signal processor 200 performs decode processing and audio signal processing to stream audio data of multichannel audio data output from the data reading section so that the stream audio data is split into the respective channel audio data. The signal processor 200 delays the split data based on the parameter and the assigned delay time, both of which are stored in the memory 213E. If necessary, image data is also delayed by the delay circuit 222. Audio data corresponding to channel of the wired transmission system is converted into analog signals by the DAC 214, output to the appropriate speaker 300 via the amplifier 215, and reproduced and output as sound. Audio data corresponding to channel of the wireless transmission system is transmitted to the appropriate speaker 300 via the transmitter 216, received by the reception processor so that the audio data being modulated, converted into analog signals, and reproduced by and output from the speaker 300 via the amplifier 215 as the sound. The image data appropriately delayed is output to the display 400 after being processed by the video output circuit 223, and reproduced by and output from the display 400 as video picture.

(Location Range Capable of Correcting)

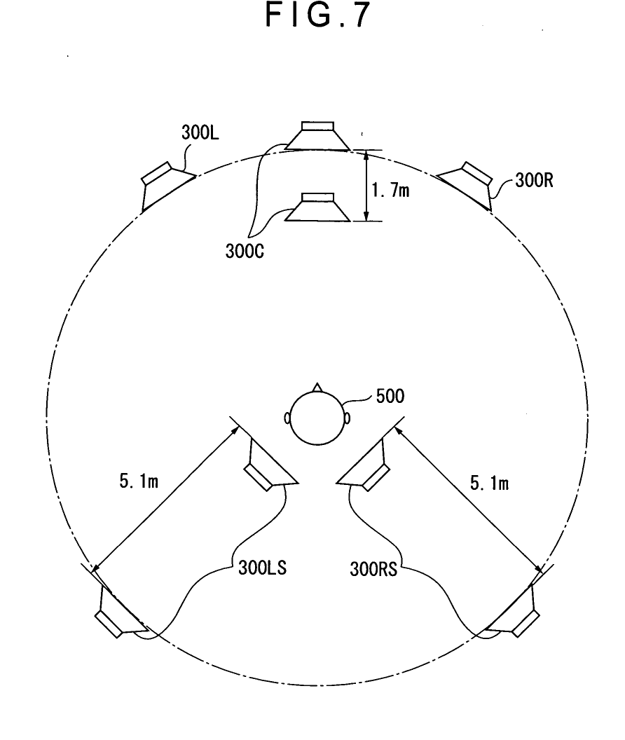

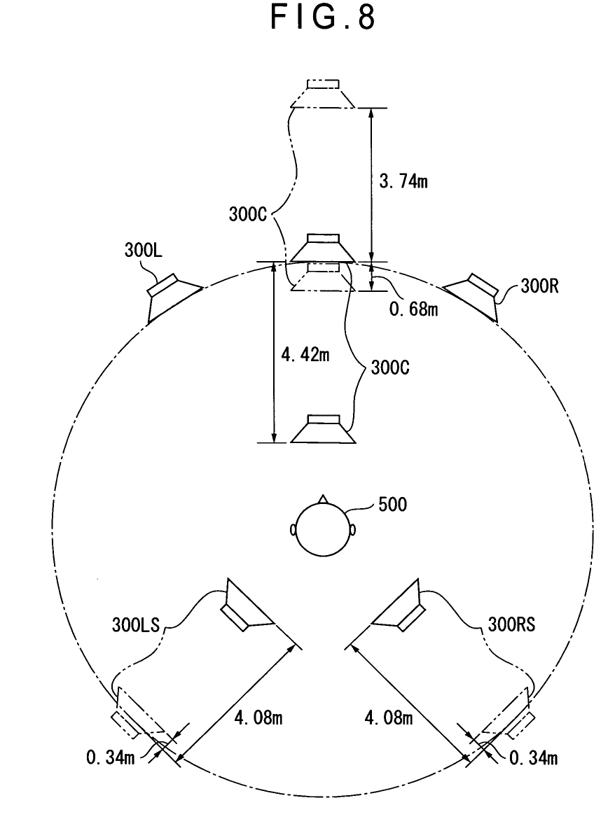

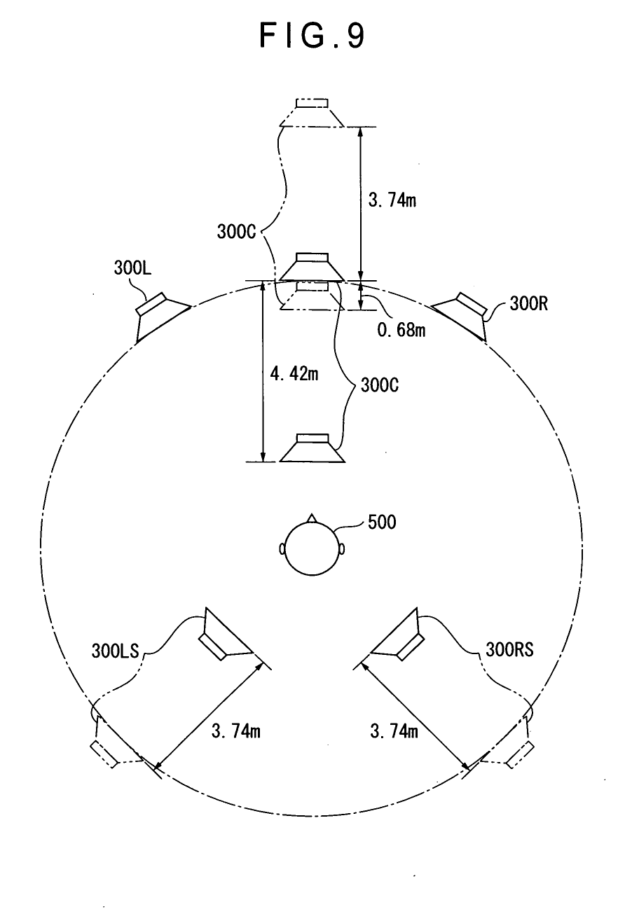

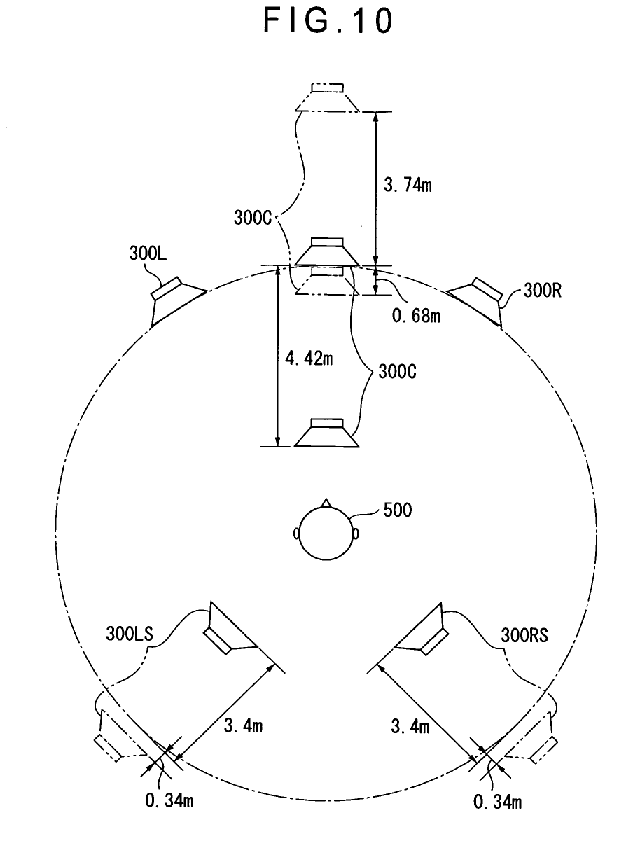

Now, the location range capable of arranging the speakers 300 upon delay processing will be described below. FIG. 7 is a conceptual diagram showing a result of delay processing when all speakers are connected in the wired transmission system as well as the display. FIG. 8 is a conceptual diagram showing a result of delay processing when certain speakers are connected in the wireless transmission system with a delay time of 12 msec. FIG. 9 is a conceptual diagram showing a result of delay processing when certain speakers are connected in the wireless transmission system with a delay time of 11 msec. FIG. 10 is a conceptual diagram showing a result of delay processing when certain speakers are connected in the wireless transmission system with a delay time of 10 msec.

In the ordinary condition that all of the speakers 300 are connected in the wired transmission system, the range is defined as indicated by equations 5 and 6. According to the relations of equations 1 and 2 that define the delay times S, C in the delay processing by the DSP 213, as shown in FIG. 7, the center speaker 300C can be located closer to the reference point by 1.7 m, and the right rear speaker 300RS and the left rear speaker 300LS can be respectively located closer to the reference point by 5.1 m.

f−1.7<c<f Equation 5

f−5.1<s<f Equation 6

On the other hand, when the right rear speaker 300RS and the left rear speaker 300LS employ the wireless transmission system, the range is defined as indicated by equations 7 and 8, 9 and 10 or 11 and 12. According to the relations of equations 3 and 4 that define the delay times F, C for the delay processing by the DSP 213, the speakers can be located within the range as shown in FIGS. 8 to 10 etc.

More specifically, when setting that the delay time t is 12 msec in the wireless transmission, the maximum delay time Fmax of the audio data R or L is 11 msec (see FIG. 4B) and the maximum delay time Cmax of the audio data C is 13 msec (see FIG. 4B), the location range as indicated by the solid lines and dotted lines in FIG. 8 is set according to the relation indicated in equations 7 and 8. In other words, when the right rear speaker 300RS and the left rear speaker 300LS are located 4.08 m forward relative to the solid line in FIG. 8, the center speaker 300C is located 4.42 m forward relative to the solid line in FIG. 8 as the location allowable range. Alternatively, when the right rear speaker 300RS and the left rear speaker 300LS are located 0.34 m forward relative to the dotted line in FIG. 8, the center speaker 300C is located in the location range of 0.68 m forward and 3.74 m backward relative to the dotted line in FIG. 8, that is 4.42 m in total.

s−0.34<c<s+4.08 Equation 7

f−4.08<s<f−0.34 Equation 8

On the other hand, when setting that the delay time t is 11 msec in the wireless transmission, the maximum delay time Fmax of the audio data R or L is 11 msec (see FIG. 4B) and the maximum delay time Cmax of the audio data C is 13 msec (see FIG. 4B), the location range as indicated by the solid lines and the dotted lines in FIG. 10 is set according to the relation indicated in equations 9 and 10. In other words, when the right rear speaker 300RS and the left rear speaker 300LS are located 3.74 m forward relative to the solid line in FIG. 9, the center speaker 300C is located 4.42 m forward relative to the solid line in FIG. 9. Alternatively, when the right rear speaker 300RS and the left rear speaker 300LS are located as to be equidistance just like the right front speaker 300R and the left front speaker 300L relative to the dotted line in FIG. 9), the center speaker 300C is located in the location range of 0.68 m forward and 3.74 backward relative to the dotted line in FIG. 9, that is 4.42 m in total.

s−0.68<c<s+3.74 Equation 9

f−3.74<s<f Equation 10

Further, when setting that the delay time t is 10 msec in the wireless transmission, the maximum delay time Fmax of the audio data R or L is 11 msec (see FIG. 4B) and the maximum delay time Cmax of the audio data C is 13 msec (see FIG. 4B), the location range as indicated by the solid lines and the dotted lines in FIG. 10 is set according to the relation indicated in equations 11 and 12. In other words, when the right rear speaker 300RS and the left rear speaker 300LS are located 3.4 m forward relative to the solid line in FIG. 10, the center speaker 300C is located 4.42 m forward relative to the solid line in FIG. 10. Alternatively, when the right rear speaker 300RS and the left rear speaker 300LS are located 0.34 m backward relative to the right front speaker 300R and the left front speaker 300L (see the dotted line in FIG. 10), the center speaker 300C is located in the location range of 0.68 m forward and 3.74 m backward relative to the dotted line in FIG. 10, that is 4.42 m in total.

s−1.02<c<s+3.4 Equation 11

f−3.4<s<f+0.34 Equation 12

As shown in FIGS. 8 to 10, the location range of the center speaker 300C is continuously changed relative to the locating distance of the right front speaker 300R and the left front speaker 300L so as to correspond to the locating distance of the right rear speaker 300RS and the left rear speaker 300LS within the range of 3.74 m in total, or 4.42 m in total in the forward and backward directions.

As described above, in this embodiment, the audio data C, R, L transmitted to the speakers 300C, 300R, 300L in the wired transmission system, the audio data C, R, L being included in the respective channels, i.e., the audio data C, R, L, RS, LS, LFE, are selectively delayed by the computing section 213F according to the reproducing time until the completion of reproducing the audio data RS, LS by the speaker 300RS, 300LS connected via the radio medium 216B as the sound in the wireless transmission system. Since the delay processing is performed not only by adjusting the locations of the respective speakers 300, but also by considering the time of modulating and demodulating upon the wireless transmission system, the audience can listen to the sound reproduced at a synchronized timing even when the audio data is reproduced through the different transmission systems by ways of the wired and radio medium.

The transmitter 216 transmits the audio data as digital signal via the radio medium 216B to the speakers 300 (e.g., 300RS, 300LS) in the wireless transmission system. This arrangement is preferable especially when transmitting the digital signal that requires to be modulated/demodulated at transmission of the audio data. For instance, the audio data is acquired from the data reading section in digital form, directly performed the decode processing and the audio signal processing, and transmitted to be reproduced by the speaker 300 without converting the digital signal into analog signal to be reproduced by the speakers 300. Therefore, the audio data can preferably be transmitted in the wireless transmission system, and audibility can be enhanced.

The computing section 213F delays the audio data according to a first locating distance from the reference point to the speaker 300C, 300R or 300L that reproduces the audio data C, R or L in the wired transmission system, the sound travel distance corresponding to the time necessary for modulating and demodulating the audio data RS, LS in the wireless transmission system and a second locating distance from the reference point to the speaker 300RS or 300LS. Therefore, the audience can listen to the sound at a synchronized timing even when employing the different transmission systems.

The delay processing is performed so that a shorter distance becomes equal to a longer distance when comparing the sum of the sound travel distance X and the locating distance of the speaker 300RS or LS in the wireless transmission system and the locating distance of the speaker 300C, 300L or 300R in the wired system. Namely, the audio data C, R, L are appropriately delayed corresponding to their locating distances. Therefore, the audience can listen to the sound at a synchronized timing according to a simple calculation even when employing the different transmission systems. Thus, the processing efficiency can be improved, thereby shortening the time until the audio data is reproduced and enhancing the audibility.

In order to perform the delay processing by the computing section 213F, the memory 213E includes the data area 213E2, where the maximum delay times are assigned, the maximum delay time being corresponding to the one of the standard data area 213E1, while all of the speakers 300 employ the wired transmission system. Even when the speakers 300 are set with only the data area 213E2 in the wireless transmission system, the data structure may be the one with only the wired transmission system or only the wireless transmission system. Therefore, the audience can listen to the sound at a synchronized timing even when employing the different transmission systems, without changing the structure of the memory 213E.

Further, when the standard data area 213E1 is also provided in the memory 213E, the audience can listen to the sound at a synchronized timing regardless to the transmission system, the delay processing may be selectively performed with the standard data area 213E1 or the data area 213E2 in accordance with the transmission system of the same system or different systems, thereby, promoting the wide usage.

The speakers 300 includes the five channels, i.e., the center speaker 300C located at the front side, the right front speaker 300R located at the front right side, the left front speaker 300L located at the front left side, the right rear speaker 300RS located at the rear right side and the left rear speaker 300LS located at the rear left side. The three areas 213E1a to 213E1c and other three areas 213E2a to 213E2c are applicable to either a same transmission system or different transmission systems, therefore, the audience can listen to the sound at a synchronized timing with simple data structure.

Since the right rear speaker 300RS and the left rear speaker 300LS, which locate relatively away from the signal processor 200, employ the wireless transmission system, wiring is not necessary, thereby preventing the appearances of the speakers from disorganizing, easily installing the speakers, and realizing the enough locating range with the data area 213E2 having the same data amount as the standard data area 213E1.

The computing section 213F recognizes the transmission system set by the input operation with the input operating section 240, and delays the appropriate audio data based on the recognized transmission system. Therefore, the audience can listen to the sound at a synchronized timing even when the transmission system is changed without providing any special arrangement.

When the image data is transmitted to the display 400 whereas the audio data of the respective channels are transmitted in the different transmission systems, the delay circuit 222 delays the image data input from the image input terminal 221 corresponding to the maximum delay time of the audio data by the computing section 213F. Therefore, the audience can listed to the sound and view the video picture at a synchronized timing.

[Modification of Embodiment]

The present invention is not limited to the above specific embodiment, but includes modifications as long as the objects of the present invention can be attained.

According to the above-described embodiment, the number of the channels is not limited to five, and two or more speakers may be applied to structure for reproducing multichannel audio data including two or more channels. A player for reproducing only audio data may be available without the display 400.

Though this embodiment is described that the audio data and the image data are read from a recording medium by the data reading section, it is not limited. The data reading section may acquire the audio data and the image data distributed over a network.

The signal processor 200 is not limited to the AV receiver. For example, the signal processor 200 may be a personal computer with the structure of the signal processor 200 being set through the installation of a program. The present invention may be a program read by the computer. Accordingly, the configuration can be widely used.

There may be provided a connection detector for detecting the connection of the terminal of the lead wire to the audio output terminal 217, and also detecting that the connected speaker 300 employs the wired transmission system. The computing section 213F may perform delay processing in accordance with the wired transmission system recognized by the connection detector. With this arrangement, the input operating section 240 is not necessary to set the transmission system in advance, the transmission system can be automatically recognized, thereby improving convenience.

Though it is described that the standard data area 213E1 and the data area 213E2 are both provided and the delay processing is performed in accordance with the transmission system status, it is not limited. For example, as described above, the data structure with only the data area 213E2 may be applicable. With this arrangement, the data structure may be the one with only the wired transmission system or only the wireless transmission system. Therefore the audience can listen to the sound at a synchronized timing even when employing the different transmission systems, without changing the structure of the memory 213E.

Other specific arrangements and steps for implementing the present invention can be appropriately modified as long as an object of the present invention can be attained.

[Advantages of Embodiments]

As the above-described embodiment, the audio data C, R, L transmitted to the speakers 300C, 300R, 300L in the wired transmission system, the audio data C, R, L being included in the respective channels, i.e., the audio data C, R, L, RS, LS are selectively delayed by the computing section 213F according to the reproducing time until the audio data RS, LS are reproduced by the speaker 300RS, 300LS as the sound in the wireless transmission system. Since the delay processing is performed not only by adjusting the locations of the respective speakers 300, but also by considering the time of modulating and demodulating upon the wireless transmission system, the audience can listen to the sound reproduced at a synchronized timing even when the audio data is reproduced through the different transmission systems by ways of the wired and radio medium.

What is claimed is:

1. An audio data processing device for reproducing audio data from a plurality of speakers located around a reference point, the device comprising:
an audio data acquiring section for acquiring the audio data; and
a delay processor for selectively delaying audio data transmitted to a first speaker connected by way of wiring in a wired transmission system out of the audio data of channels respectively corresponding to the speakers on the basis of a time until the audio data transmitted to a second speaker connected by way of a radio medium in a wireless transmission system is reproduced from the second speaker.

2. The audio data processing device according to claim 1, further comprising a transmitter that transmits the audio data as a digital signal to the second speaker in the wireless transmission system.

3. The audio data processing device according to claim 1, wherein the delay processor delays the audio data according to a first locating distance from the reference point to the first speaker, a sound travel distance corresponding to a time necessary for modulating and demodulating the audio data transmitted to the second speaker in the wireless transmission system and a second locating distance from the reference point to the second speaker.

4. The audio data processing device according to claim 3, wherein the delay processor delays the audio data based on the difference between the first locating distance and the total distance of the second locating distance and the sound travel distance.

5. The audio data processing device according to claim 1, further comprising:
a storage that stores the audio data so that the delay processor delays the audio data,
wherein the storage has a data area having the same size as a standard data area that is used when a same transmission system is applied to the speakers, and a delay time of the first speaker is assigned to the data area.

6. The audio data processing device according to claim 5, wherein the delay processor delays the audio data based on either the data area or the standard data area.

7. The audio data processing device according to claim 1, wherein the first speaker represents a center speaker located at the front relative to an audience, a right front speaker located at the front right side and a left front speaker located at the front left side, and the second speaker denotes a right rear speaker located at the rear right side relative to the audience and a left rear speaker located at the rear left side.

8. The audio data processing device according to claim 1, further comprising:
a connection detector for detecting that the speaker is connected in the wired transmission system so that the audio data can be acquired,
wherein the delay processor delays the audio data transmitted based on the connection status of the respective speakers detected by the connection detector.

9. The audio data processing device according to claim 1, further comprising:
an image data acquiring section for acquiring image data;
a display for reproducing the acquired image data; and
an image data delay processor that delays, at transmission of the image data, the image data by a time corresponding to a maximum delay time of the audio data delayed by the delay processor.

10. An audio data processing method for reproducing audio data from a plurality of speakers located around a reference point, the method comprising the step of selectively delaying audio data transmitted to a first speaker connected by way of wiring in a wired transmission system out of the audio data of channels respectively corresponding to the speakers on the basis of a time until the audio data transmitted to a second speaker connected by way of a radio medium in a wireless transmission system is reproduced from the second speaker.

11. The audio data processing method according to claim 10, the method further comprising the steps of:
acquiring image data; and
at transmission of the image data, delaying the image data by a time corresponding to a maximum delay time of the audio data delayed by the delay processor.

12. An audio data processing program executing an audio data processing method for reproducing audio data from a plurality of speakers located around a reference point by the computing section,
the method comprising the step of selectively delaying audio data transmitted to a first speaker connected by way of wiring in a wired transmission system out of the audio data of channels respectively corresponding to the speakers on the basis of a time until the audio data transmitted to a second speaker connected by way of a radio medium in a wireless transmission system is reproduced from the second speaker.

13. A recording medium storing an audio data processing program in a manner readable by the computing section,
wherein the program executes an audio data processing method for reproducing audio data from a plurality of speakers located around a reference point by the computing section,
the method comprising the step of selectively delaying audio data transmitted to a first speaker connected by way of wiring in a wired transmission system out of the audio data of channels respectively corresponding to the speakers on the basis of a time until the audio data transmitted to a second speaker connected by way of a radio medium in a wireless transmission system is reproduced from the second speaker.
